(19) United States
(12) Patent Application Publication
(10) Pub. No.: US 2021/0399277 A1
(43) Pub. Date: Dec. 23, 2021

(54) METHOD OF PRODUCING THICK SULPHUR CATHODES FOR LI-S BATTERIES

(71) Applicant: Monash University, Clayton (AU)

(72) Inventors: Mahdokht SHAIBANI, Clayton (AU); Mainak MAJUMDER, Clayton (AU)

(73) Assignee: Monash University, Clayton (AU)

(21) Appl. No.: 17/292,736

(22) PCT Filed: Nov. 10, 2019
(86) PCT No.: PCT/AU2019/051239

§ 371 Date: May 11, 2021

(30) Foreign Application Priority Data
Nov. 12, 2018 (AU) 2018904381

(51) Int. Cl. H01M 4/136; H01M 4/1397; H01M 4/62; H01M 4/36; H01M 10/052

(52) U.S. Cl. CPC H01M 4/136; H01M 4/1397; H01M 4/625; H01M 2004/028; H01M 4/364; H01M 10/052; H01M 4/622

(57) ABSTRACT

A method of producing Sulfur cathodes for Li—S batteries utilising dry mixing of constituents (sulphur, carbon and binder) or semi-dry mixing. The resultant structure binds the neighbouring particles without covering them, i.e. by attaching a few parts of a particle to other neighbouring particles provides a solution for the successful cycling of thick and ultra-thick sulfur cathodes. Such an approach provides a robust thick cathode where particles are strongly bonded with minimal surface coverage with the polymer providing sufficient room to expand during lithiation. Bridging bonds are formed within the cathodes.

### FIELD OF THE INVENTION

The present invention relates to Li—S batteries, in particular a method of producing thick sulphur cathodes with high electronic & ionic mobility.

### BACKGROUND TO THE INVENTION

Li—S batteries are considered to be a potential alternative to rechargeable Li-ion battery technology. This is because the theoretical energy density of these batteries is 2600 Wh/kg, substantially larger than that of Li-ion batteries (˜200 Wh/kg). Additional benefits of Li—S batteries arise also because all ingredients: Li (metal-anode), Sulfur & Carbon (cathode) are relatively cheap and abundant. However, to achieve cell level energy content closer to Li-ion cells, it is imperative that the amount of Sulfur in the electrodes be increased, otherwise the cells do not make use of their large theoretical energy density. Current methods to produce the sulphur cathodes, especially the thicker ones which can provide >3-4 mgs/cm2 are hampered by many issues including lack of ionic mobility (for the electrolytes to access the reactive sites) and/or electronic mobility. These issues lead to poor Sulfur utilization, undeveloped/under-developed electrochemical profiles leading to poor performance at high C ratings, lower columbic efficiency—all of these lead to poor overall performance, whenever thick (high sulphur content per unit area) Sulfur cathodes are used.

There are several methods reported in patent literature and peer-reviewed publications for producing these cathodes, for e.g U.S. Pat. No. 9,577,243 B2 (Use of expanded graphite in Li-sulfur batteries). Typically, a carbon source & sulphur source, are homogenized by melting Sulfur (˜155-200° C.). Thereafter, a binder material typically in copious quantities of solvents such as water, ethanol, NMP etc. are utilized to prepare a castable formulation from the mixture. There are some other variations of the process including the use of S and C particles separately (without forming the composite by melting Sulfur) in the literature (US20120119161A1, CN105470518A, WO2013049663A1). However, in all these cases two phenomena are inevitable: full or partial coverage of the Carbon and Sulfur particles by the surface tension/capillary forces from the dissolved binder system. Such a microstructure inevitably leads to lower electrolyte accessibility and sulphur utilization—adverse effects that are never as detrimental in thin cathodes. Also during lithiation, the cathodes undergo volume expansion which is rather difficult to accommodate in the dense microstructure reported in prior art, resulting in structural fragmentation of electrodes. It is to be noted that the binders are required for increasing the processability of the electrodes to a large extent, and also the mechanical integrity of the electrodes during the volume expansion upon cycling; however, the capillary forces in the solvent-binder systems forces the polymers into covering the reactive surfaces as well as inside the pores of Carbons, limiting their overall electronic conductivity and reactivity. The electrode in Lithium based batteries comprises the active material which is responsible for delivering the energy through absorption and release of lithium ions, a conductive agent which provides electrical conductivity throughout the entire electrode network and a binder to glue the former two together and also to the current collector. In order for the electrode active material to undergo the electrochemical reactions and deliver the energy, ions should be transferred through the electrolyte and electrons should be transferred via the conductive agent. Electrolyte diffusion problems or loss of contact of the active material from the conductive agent results in localized inactiveness and loss of capacity. Amongst all high capacity electrodes, electrode pulverization is most severely experienced in the Si anode of Li-ion batteries. With a specific capacity of one order of magnitude higher than graphite, Si anode suffers from a substantial volume change of 400% upon absorption/release of Li ions, effectively degrading the electrode integrity within a small number of cycles. Being the major limitation for the realization of Si battery, the focus of the literature is to explore binders that maintain the electrode integrity upon cycling. As compared to the 4200 mAh g−1 silicon anode, the 1670 mAh g−1 sulfur cathode in the Li—S battery system, exhibits around 78% of volume change, much less than that of Si anode and yet quite enough to disconnect the insulating sulfur particles from the conductive network of the cathode and loss of capacity. The adverse effect of electrode disintegration becomes dramatically more pronounced with the increase in the areal sulfur loading of the cathode, a key parameter for achieving commercial-level areal capacities.

In contrast to the traditional literature of Li—S battery, which focuses on exotic cathode host materials with polysulfide confinement/adsorption abilities, the recent literature has shown to realize the importance of the cathode integrity. A good number of papers have devoted their attention to better binder systems, demonstrating improved performances compared to that of PVDF-based cathodes. Given the more maturity of the Si literature and the much higher volume change that Si anode experiences; an idea is to use suitable binders that are already proved reasonably successful in the composition of Si anodes. Such inspirations have resulted in the investigation of several binder systems, including but not limited to Gum Arabic, CMC/SBR guar gum and xanthan gum and cross-linked CMC-Citric acid. In spite of superiority over PVDF, these translations have not resulted in reasonably stable Li—S batteries. Mainly due to the fact that in addition to the volume change, Li—S system also suffers from the highly investigated issue of polysulfide shuttle and just as importantly the insulating nature of active materials. The reaction between lithium and sulfur is problematic in the Li—S system because the by-products of the multi-steps discharge reactions or the so-called polysulfides are highly soluble in the liquid electrolyte of the battery, resulting in the special shuttle phenomena in this system. As a consequence of the shuttle effect, the high order polysulfides diffuse through the membrane separator of the battery to the anode side where they react with the lithium to form low order polysulfides and migrate back to the cathode side. This effect greatly contributes to the loss of active material, lower columbic efficiency and rapid capacity decay upon cycling.

Novel binder systems have been critically designed to add polysulfide absorbing functionality to the binder such as the conductive, elastic, and electroactive nanocomposite binder composed of polypyrrole and polyurethane (PPyPU) (4.6 mg), and modified cyclodextrin (C-β-CD) (3 mg). The general conclusion from studies that targeted retarding the shuttle of polysulfides is that binders with polar/electronegative functional groups can serve better in the sulfur cathode. However, as for the latter issue, the insulating nature of the active materials, few have sought to address it in thick cathodes. Dissolved binder tends to create a continuous network across the bulk of the electrode, which is still permeable to Li ions in LIB electrodes given the very small amount of binder used (1-2%). In silicon anode or sulfur cathode considerably higher fractions of the binder is required to hold the electrode together (5-30%), which via the commonly used methodology of using a dissolved binder system, could effectively reduce a good fraction of the active surfaces—a major reason for the low utilization of high loading electrodes.

It is then clear that to achieve optimum electronic and electrochemical performance in thick sulfur cathodes, the design rules for their fabrication should be revisited such that the number of electrochemically available reaction sites would be maximized. A new design, however, should be able to find its way from laboratory to industry. In order for the Li—S chemistry which uses the extremely cheap sulfur as the active material to shine in the rich space of beyond LIB, the other two major electrode components, binder and conductive agent cannot be out of the typical LIB electrodes recipe, unless for more specialized applications.

The object of this invention is to provide a method of producing thick Sulfur cathodes to alleviate the above problems, or at least provide the public with a useful alternative.

### SUMMARY OF THE INVENTION

In a first aspect the invention provides a method of producing a sulfur cathode for a rechargeable energy storage cell, the method comprising the step of mixing in a dry state a sulfur containing source, a conductive agent and a binder to form a dry mix.

Preferably the sulfur containing source comprises 5 to 95% sulfur by volume, preferably more than 50% sulfur, more preferably more than 65% sulfur, and most preferably more than 75%.

Preferably the sulfur containing source contains approximately 80% sulfur by volume.

Preferably the sulfur containing source is selected from the group of: crystalline sulfur, colloidal sulfur, Li₂S and MoS₂.

Preferably the dry mix comprises 1 to 40% binder by volume, preferably less than 20%, more preferably less than 15% binder, and most preferably less than 10%.

Preferably the dry mix comprises approximately 5% binder by volume.

Preferably the binder is selected from the group of: Polytetrafluoroethylene (PTFE), polyvinylidene fluoride (PVDF), Gum Binders such as Gum Arabic, Xanthan gum, and Guar gum, Natural Cellulose based binders, Polysaccharides such as Na-CMC, Li-CMC, Na-Alginate, Polyacrylates, Aliphatic Polymers such as Polyvinyl butyral (PVB), Aromatic Polymers such as Styrene-Butadiene Rubber.

Preferably the Polysaccharide based binder is selected from the group: CMC, Na alginate and CNC.

Preferably the dry mix comprises 0 to 50% conductive agent by volume, preferably less than 35% conductive agent, more preferably less than 20% conductive agent, and most preferably less than 15% conductive agent.

Preferably dry mix comprises approximately 10% conductive agent by volume.

Preferably the conductive agent is a carbon based material such as high surface area activated carbon, highly conductive expandable graphite, CNT, CNF, graphene, or a conductive polymer.

Preferably the conductive agent is selected from the group of: carbon black, activated carbon and graphite.

Preferably the method further comprising the step of mixing the dry mix with a solvent to form a processable mixture.

Preferably the amount of solvent added to the dry mix is below the solubility of the binder, and preferably well below the solubility of the binder.

Preferably the solvent is selected from the group of: water, NMP, alcohol based solvents and DMF.

Preferably the method further comprises the step of processing the mixture onto a current collector to form the sulfur cathode.

In a second aspect the invention provides a rechargeable energy cell comprising a lithium anode a separator and a sulfur cathode produced in accordance to the method, wherein the cell further comprises a polysulfide retentive layer.

Preferably the retentive layer is coated on the sulfur cathode.

Preferably the polysulfide retentive layer is free standing between the sulfur cathode and the separator.

Preferably the polysulfide retentive layer is coated on a separator support.

Preferably the polysulfide retentive layer is a high surface area carbon.

Preferably the high surface area carbon is selected from the group of: graphene, carbon and CNT.

Preferably the polysulfide retentive layer is a functional polymer.

Preferably the functional polymer is selected from the group of gum Arabic, CMC and Na alginate.

In a further aspect the invention provides a rechargeable energy cell comprising a lithium anode, an electrolyte and a sulfur cathode produced in accordance to any one of the preceding claims, wherein he electrolyte contains an organic solvent, preferably (DME) and 1,3-dioxolane (DOL).

Preferably the solvent comprises a mixture of DME and DOL, such as a 50:50 (v/v) mixture.

Preferably the electrolyte contains a soluble lithium salt to provide ionic conductivity between the anode and the cathode.

Preferably the lithium salt comprises at least one selected from lithium bis(trifluoromethane)sulfonimide (LiTFSI) and lithium trifluoromethanesulfonate, and preferably comprises LiTFSI.

Preferably the lithium salt is present in the electrolyte at concentrations between 0.1 and 5.0 M, preferably between 0.25 and 1M, for example approximately 1.0 M.

Preferably the electrolyte comprises lithium nitrate (LiNO3), in a concentration of between 0.05 and 1 M, for example 0.5M.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1A is a low resolution scanning electron microscopy image showing the microstructure of a cathode produced using the method of the invention

FIG. 1B is a high resolution image of a portion of FIG. 1A showing links formed using the method of the invention.

FIG. 1C is a schematic representation of the microstructure produced showing the links formed.

FIG. 2 shows viscosity curves comparing cathode slurries made in accordance with the invention to prior art cathode slurries.

FIG. 3 shows Raman spectroscopy analysis comparing cathode slurries made in accordance with the invention to prior art cathode slurries.

FIG. 4 shows conductivity analysis comparing cathode slurries made in accordance with the invention to prior art cathode slurries.

FIGS. 5A to 5C show comparative discharge graphs for the cathodes.

FIG. 6 shows long term cycling performance of the cathodes at high loads.

FIG. 7 shows the cycling performance of a cathode formed from colloidal sulfur, CMC binder and expanded graphite as the conductive agent. The inset shows an SEM image of the bridging mechanism achieved.

FIGS. 8A to 8C show SEM images of the bridging mechanism achieved at increasing resolutions for a cathode formed from colloidal sulfur, CMC binder and activated carbon as the conductive agent.

FIG. 9 shows the cycling performance of a cathode formed from colloidal sulfur, CMC binder and activated carbon as the conductive agent.

FIGS. 10A to 10D show SEM images of the bridging mechanism achieved at increasing resolutions for a cathode formed from colloidal sulfur, PVDF binder and expanded graphite as the conductive agent.

FIGS. 11A to 11C show the cycling performance of a cathode formed from colloidal sulfur, PVDF binder and expanded graphite as the conductive agent for varying concentrations of undissolved PVDF binder.

FIG. 12 shows the cycling performance of ultra-high loading cathodes prepared via the un-dissolved binder approach in terms of gravimetric capacity, areal capacity and columbic efficiency at 0.1 C rates.

### DETAILED DESCRIPTION OF THE INVENTION

The following detailed description of the invention refers to the accompanying drawings. Wherever possible, the same reference numbers will be used throughout the drawings and the following description to refer to the same and like parts.

The present invention provides a method of producing thick Sulfur cathodes which overcomes the limitations of the prior art methods. The method develops ‘bridging’ bonds between the particles which overcomes the aforementioned drawbacks. A key feature is that the electrodes produced by this method are composed of particles which are not covered by binders thereby producing an open structure with accessible Sulfur and Carbon, which enables high discharge capacities in Li—S coin cells with sulphur loading from 4-18 mgs/cm2. The sulphur particles and carbon particles of the cathode produced are connected by ‘bridging’ bonds resulting in a microstructure remarkably different from that produced by the state-of-art where particles are constrained in a network of polymeric binder. The structure achieved by the method provides sufficient room for particle growth and volumetric expansion during cycling and prevents microstructural collapse of the cathode enabling very attractive cycling performance. In addition the slurry has rheological features suitable for manufacturing electrodes by traditional processes used in the battery manufacturing industry.

The novel manufacturing process for producing electrodes of the present invention provides moves away from the wet-mixing step reported in most Sulfur containing cathodes reported till date, instead using a combination of dry mixing (sulphur, carbon and binder) and semi-dry (with minute quantities of solvent) homogenization. The method ensures that that electrodes are formed with rheological properties where capillary forces are less operative & visco-elastic forces allow the formation of bridging bonds between the active particles. The method is the first know disclosure of a slurry formulation allowing bridging bonds to be achieved in sulfur cathodes. An additional step in this disclosure is the use of colloidal sulphur particles, which obviates the need for melt-mixing step described in prior art. Sulphur in the form of colloidal particles ensure that the particles are uniformly distributed across the microstructure and compatibility with the process described in this disclosure.

Disclosed hereafter is a novel methodology to prepare sulfur cathodes with Sodium carboxymethyl cellulose (Na-CMC), a high-modulus binder with rich carboxylic groups, results in remarkably stable high loading sulfur cathodes. Unlike many commonly used recipes for preparing the cathode slurry, which follow wet mixing protocols using pre-dissolved binder solutions, undissolved/partially dissolved Na-CMC with its high content of carboxylic groups lead to a sufficient number of bridging bonds between the particles to hold them together without covering them unduly. This approach enables the successful fabrication of very thick cathodes (as high as 20 mgs cm−2 and above) and allows for very high active material utilization due to the considerably increased free reaction surfaces of the active materials and offers space to accommodate the volume change during cycling due to the high degree of freedom of particles to expand.

The general design rule for the electrodes in LIB is very simple: the greater the amounts of active materials filling up the restricted volume, more energy can be obtained. Thus, any components other than active materials, such as binders, electrolyte, separators, and conductive additives, should be minimized. However, the very different energy delivery mechanism and the much higher specific capacities in sulfur cathodes or Si anodes demand different rules for designing the battery components. Much higher fractions of conductive additives (typically high surface area carbons) demand the use of more binder and more electrolyte. Even though this will adversely affect the energy density of the cell, it can be compensated with the use of higher areal loadings of the active material, which as opposed to those of the commercial LIB electrodes have much higher specific capacities. From studies, it can be concluded that fabrication of relatively robust thick sulfur cathodes is feasible with the help of cellulose-based binders. The uniform distribution of carbon and sulfur in the cathode is of crucial importance as Sulfur, Li2S, and the polysulfide intermediates are insulting and will not be able to take part in the redox reactions if they lose their physical contact with the conductive carbon.

The present method provides a shift from the commonly used networking mechanism to a bridging mechanism where the stiff binder binds the neighbouring particles without covering them, i.e. by attaching a few parts of a particle to other neighbouring particles provides a solution for the successful cycling of thick and ultra-thick sulfur cathodes. Such an approach provides a robust thick cathode where particles are strongly bonded with minimal surface coverage with the polymer and just as importantly sufficient room to expand during lithiation. In order to realize these forces in a thick sulfur cathode, the method of the invention provides at least 10% of a cellulose-based binder.

The method exploits the abundant carboxyl functional groups of the Na-CMC and the ideal submicrometer sized colloidal sulfur particles (instead of micrometre-sized elemental sulfur); quite homogeneous electrode mixtures can be obtained via dry mixing of S/C/CMC without the need for wet mixing. In contrast to the common electrode making practices, a highly robust ultra-thick cathodes is formed out of such a mixture with the addition of a minimal amount of water, enough to wet the CMC particles that are already homogenously distributed in the electrode mixture.

The present invention involves the method of preparation of an electrode, not the materials used per se, nor their proportions. The method can be employed with compositions matching those used in contemporary studies. To demonstrate the invention and its advantages over the prior art four thick sulfur cathodes (≥7 mg cms−2) with identical compositions (70% S, 20% C, 10% CMC) yet different slurry preparation methods (slurry formulation) were produced. These cathodes will be referred to as Cathodes A-D for the purpose of comparison.

Cathodes A and B were prepared in accordance with a first and second method of the invention to establish bridging bonds in the cathodes. For both cathodes, all the ingredients were mixed at once for 48 hours followed by addition of DI water to make a slurry. In cathode A, water was added gradually to the mixture just enough to wet the CMC particles such that they can establish bonds with their neighbouring particles and a castable paste would be obtained. The required amount of water for this was found to be around 1.5 mL/g electrode material equivalent to 65 mg CMC/mL water, well above the solubility limit of CMC in water at room temperature. For cathode B, the amount of water added to the mixture of S/C/CMC was around 5 mL/g electrode material.

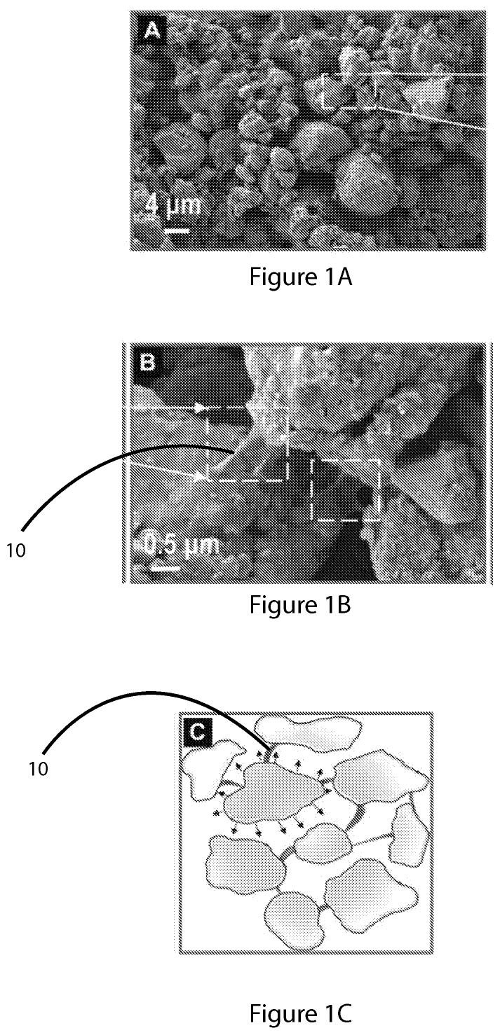

FIG. 1A shows a scanning electron microscope image of cathode A at a resolution to reveal its microstructure. FIG. 1B shows a portion of FIG. 1A at higher resolution, revealing a bridging bond 10 produced as a result of the method of the invention. FIG. 1C is a schematic representation of the structure produced.

Cathodes C and D were prepared based on the most suggested prior art mixing method for fabrication of LIB electrodes which is also the typical practice in the literature of Li—S: mixing of active material and conductive agent, both in powder form, to establish a good conductive network, followed by blending in the pre-dissolved binder solution to provide good adhesion between particle/particle and particle/current collector. In cathode C, the pre-dissolved binder solution is a solution of 20 mg CMC/mL water and in cathode D the pre-dissolved binder solution is a solution of 20 mg CMC/mL cross-linking solution. The mixture is continuously mixed for several hours to ensure good dispersion. For cathode C and D, the amount of solvent added to the mixture of S/C/CMC was around 5 mL/g electrode material similar to that of cathode B. For Cathode C DI water was used as the solvent, whilst a pH 3 cross linking solution was used for Cathode D.

Various tests have been performed on the cathodes which reveal the improved properties achieved as a result of the method of the invention.

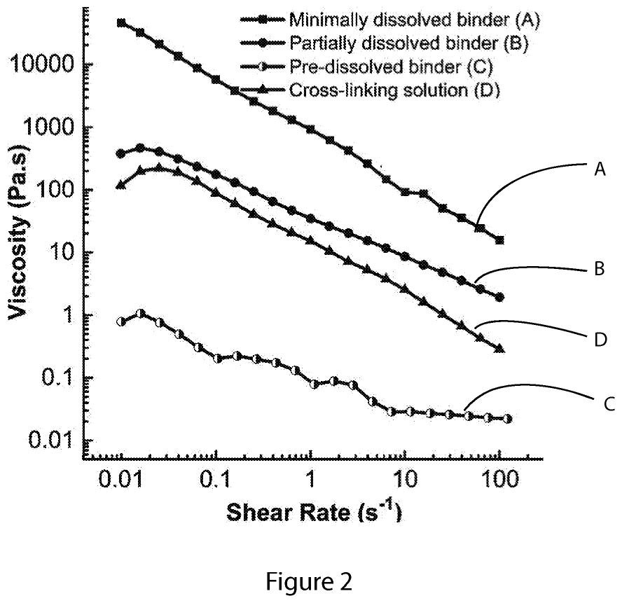

A first test compared the rheological properties of the cathodes by measuring the viscosity of the cathodes was measured at a 0.01 s⁻¹ shear rate. Cathode A had a viscosity of 45,100 Pa·s, Cathode B 379 Pa·s, Cathode C 0.782 Pa·s and Cathode D 17 Pa·s. Viscosity curves for the slurries used to make the four different electrodes are shown in FIG. 2. A significant shear thinning behaviour is observed for the slurry prepared for fabrication of Cathode A. The dramatic drop in viscosity with increasing shear rate over time reveals a very high-solid-content slurry. The shear thinning behavior is less dramatic in slurries of cathode B and Cathode D due to their lower solid content. On the other hand, the viscosity curve obtained from the slurry prepared for fabrication of cathode C, appeared to approach a relatively constant Newtonian viscosity at a higher shear rate, suggesting complete particle dispersion. The viscosity at very low shear rates (0.01 s⁻¹) also shows pronounced differences for various slurries: a more than 50,000 fold and a nearly 500 for the slurries in our work (Cathode A and B, respectively) compared to that of the typical practice in the literature (cathode D). The difference in viscosities is not quite as dramatic in the high shear rate region due to the effect of shear thinning. The very high viscosity of slurry A is expected due to its very high solid content and a water content below the minimum amount required for dissolving CMC. The marked difference between viscosities of slurry B and slurry C is, however, interesting given that both slurries are identical in terms of solid content and directly demonstrates the influence of slurry preparation on the rheological behavior of electrode slurries.

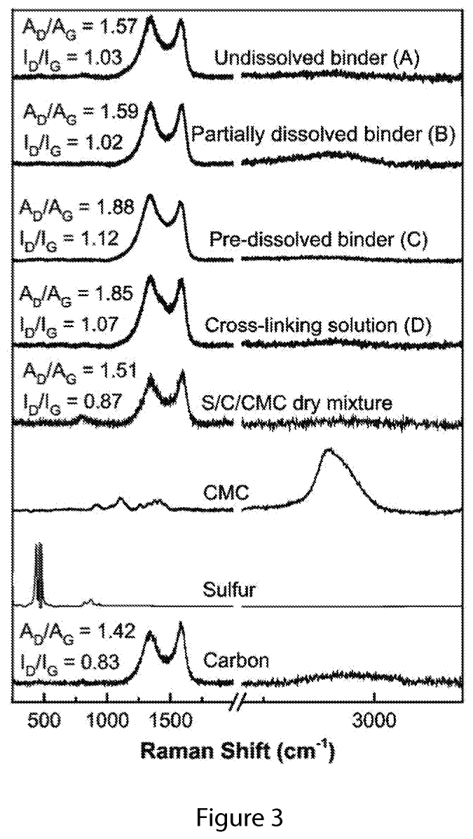

Raman spectroscopy analysis was conducted on the four cathodes as shown in FIG. 3 in order to determine the presence of isolated materials which would indicate ineffective mixing. The fraction of active material in a typical sulfur cathode (50-80%) is considerably less than that of LIB electrodes (80-97%) and consequently, the fraction of inactive materials are considerably more. In addition, the inactive materials carry more responsibility in a sulfur cathode. Sulfur and polysulfides are insulating while the active materials in LIB electrodes are conductive or semiconductors, highlighting the necessity of good contact between carbon and sulfur. In fact, isolated sulfur/polysulfide particles in the network of the cathode are as detrimental as polysulfides permanently dissolved in the electrolyte. This isolation may occur both during fabrication of the cathode and during cycling where the latter seems to have been the inevitable cause to date. Similar to the conducting agent, the binder also plays a more crucial role other than simply gluing the particles to each other and to the current collector and should accommodate the volume change and maintain the cathode integrity during cycling. It is then of no doubt that, the homogeneous distribution of ingredients across the sulfur cathode is even more crucial compared to that of LIB electrodes. Quite importantly, we noted that to achieve such a homogeneous distribution, wet mixing of active material/carbon mixture in a pre-dissolved binder solution is not necessarily the best route as suggested by the rich literature of LIB electrodes. FIG. 3 shows Raman spectroscopy analysis of the electrode materials collected from the four cathodes, the electrode mixture of cathodes A and B, and the individual ingredients. It is evident that no vibration modes can be assigned to sulfur or CMC neither in any of the four cathodes nor in the electrode mixture (S/C/CMC), demonstrating the effectiveness of dry mixing as expected. The elemental mapping analysis on cathode B agrees with this observation. Elemental mapping images collected also show matched spatial distributions of sulfur, carbon, and Na-CMC, demonstrating the homogenous distribution of all three ingredients across a cathode prepared via dry mixing approach.

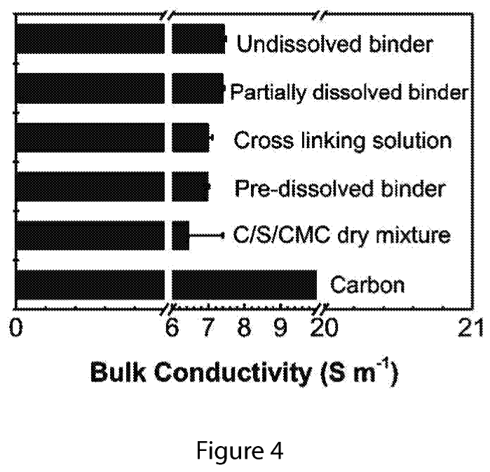

The intensity of the D band corresponds to the degree of disorder of the carbon material used as the conductive agent in the electrode mixture, which is usually attributed to the breakdown of the lattice symmetry and sp3 orbital hybridization on carbon. Additionally, the intensity of the G-band, IG, which is located in the region ˜1580-1590 cm⁻¹, corresponds to the degree of order in the system as a result of planar sp2 orbital hybridization on carbon in crystalline graphite. In the present context, the ratio of ID/IG can be used to quantitatively compare the degree of presence of surface functional groups in the carbon of the cathode. It is noted that the ID/IG of cathodes prepared via the dry mixing approach is lower compared to that of cathodes prepared via the commonly used method of wet mixing in pre-dissolved binder solutions, possibly, because carbon in the latter cases is more sp3 carbon induced by large number of surface functional groups of dissolved CMC. Also observed a clear correlation between the bulk electrical conductivity of cathodes and peak ratios (ID/IG), higher conductivity was measured when lower ID/IG value was observed, as can be seen in FIG. 4.

In addition to the above quantitative studies, detailed SEM studies in a wide range of magnifications have been undertaken to further clarify the effect of slurry preparation on the microstructure of thick sulfur cathodes. Low-magnification SEM images show crack-free robust microstructures for all cathodes. However, even at this low magnification, these set of cathodes show clear microstructural differences. Cathode C and D show very compact microstructures as expected from the way they were prepared, demonstrating the effectiveness of dissolved CMC binder for fabrication of crack-free electrodes. Quite differently, cathode B shows an in-continuous network of big clusters and cathode A shows a continuous network of small distinguishable particles. The bonding between the clusters in cathode B and the particles in cathode A is not, however, observable at low magnification.

High-resolution SEM analysis provides a powerful tool to gain a clear insight into the bonding mechanisms in these set of cathodes. The polymer coating on all the particles are evident in cathode C and D. Trapping of the particles in a continuous network of polymer, not only diminishes the active surface area available for redox reactions but the microstructure induced ionic transport limitations in such compact microstructures would adversely affect the battery performance for thick and dense electrodes at high C-rates. Just as importantly, there seems to be very little room to buffer the volume change in these dense cathodes and microstructure fragmentation and particle isolation is expected upon cycling. As evident in high-resolution SEM images, this method efficiently converted the networking mechanism observed in electrodes fabricated via dissolved binder system or cross-linking with evenly distributed bridging bonds across the cathode. In these cathodes, not only the majority of surfaces are available for redox reactions but also the particles or clusters seem to have plenty of buffering room without being constrained amongst several neighbouring particles.

Quite importantly, with both dry mixing approaches, no issues are found when increasing the areal density of the cathode to values as high as 20 mg·cm⁻² and above. On the other hand, when fabricating ultra-thick cathodes out of slurries with pre-dissolved binder solutions, coating delamination from the thin Al current collector happened.

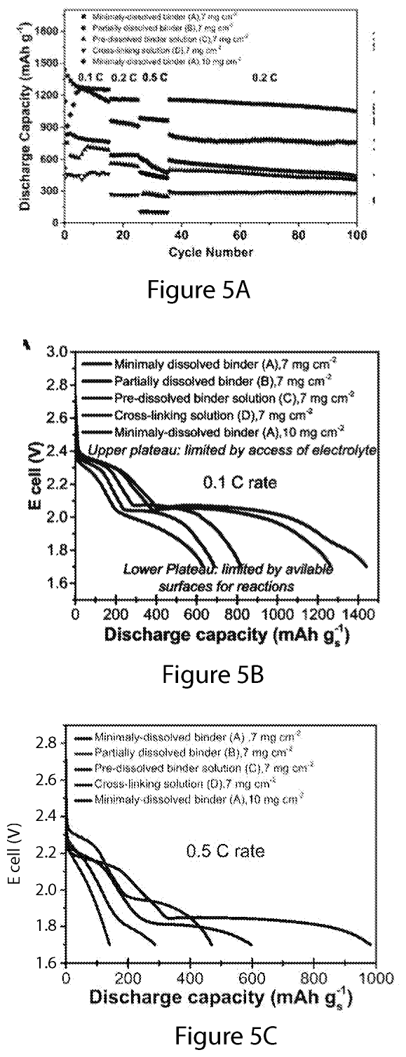

Cycling performance tests were performed on the cathodes under different cycling rates, from as low as 0.1 C rate to allow for achieving high capacities, to as fast as 0.2 C rate to evaluate the cathodes response at high currents as shown in FIG. 5A. It is clear that whilst cross-linking helps with the fabrication of dense high loading cathodes, it results in poor performance metrics. The uptake of the electrolyte is the main mechanism for Li+ diffusion in the cathode and it can be inferred from the discharge profile of the cathodes seen in FIGS. 5B and 5C that electrolyte access is being severely limited by the continuous polymeric network across the cathode. Further, the undeveloped lower plateau of the cross-linked cathode demonstrates lack of available reaction surfaces—again a result of polymer coating on the particles.

The cathode prepared via the typical practice of using a pre-dissolved binder solution demonstrates good metrics at lower rates of 0.1 and 0.2 C but poor performance at 0.5 C rate as can be seen in FIG. 5A. SEM images show that the polymeric network is not continuous enabling good permeability for the Li ions through the cathode and resulting in a well-developed upper plateau. However, the coating layer on the particles demonstrates its detrimental effects on the electronic properties, leading to a short lower discharge plateau. In a direct comparison with this cathode, the cathode prepared via our dry mixing approach, with an identical amount of solvent, shows a clearly more developed lower plateau as shown in FIG. 5B. The difference is considerably more pronounced at the higher rate of 0.5 C—a direct result of much less particle coverage with the binder as seen in FIG. 5C.

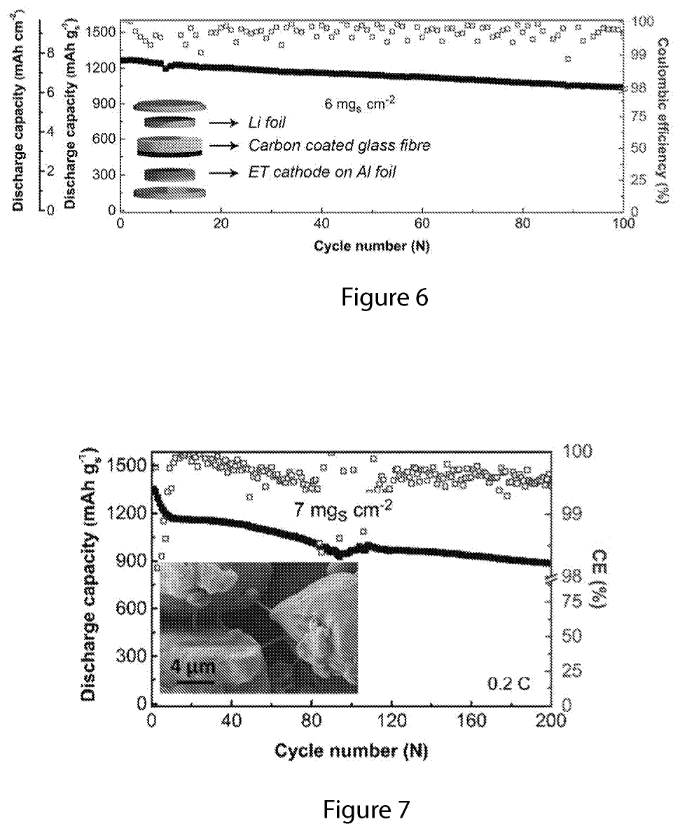

The marked improvement in metrics, however, happens when the dissolution of the binder in the cathode slurry has been minimized. Cathodes fabricated out of ultra-high viscosity slurries seem to have not fabrication challenges nor cycling difficulties. FIG. 6 shows the long-term cycling performance of these cathodes at high and ultra-high loadings. In addition to cycling stability, impressive columbic efficiencies (CE) are achieved in both cases. The combination of excellent cyclability and CE of above 99% is unique in the literature of high-loading sulfur cathodes.

Further examples of the structures achieved and performance obtained for various materials are show in FIGS. 7 to 12.

In a further example a sulfur cathode is prepared from colloidal sulfur with minimally dissolved CMC binder and expanded graphite (Ex-Gr) as the conductive agent. The expanded graphite used has near zero porosity and excludes the stress absorbing effect of the conductive agent compared with porous activated carbon. SEM analysis seen in the inset of FIG. 7 demonstrates a similar bridging mechanism as seen in FIG. 1B. The cycling performance was also comparable and it can be inferred that the use of a highly porous carbon is not required for absorbing the cycling stress of an ET electrode. The graph of FIG. 7 shows the excellent cycling performance at 0.2 C; CE remains close to 100% after 200 cycles.

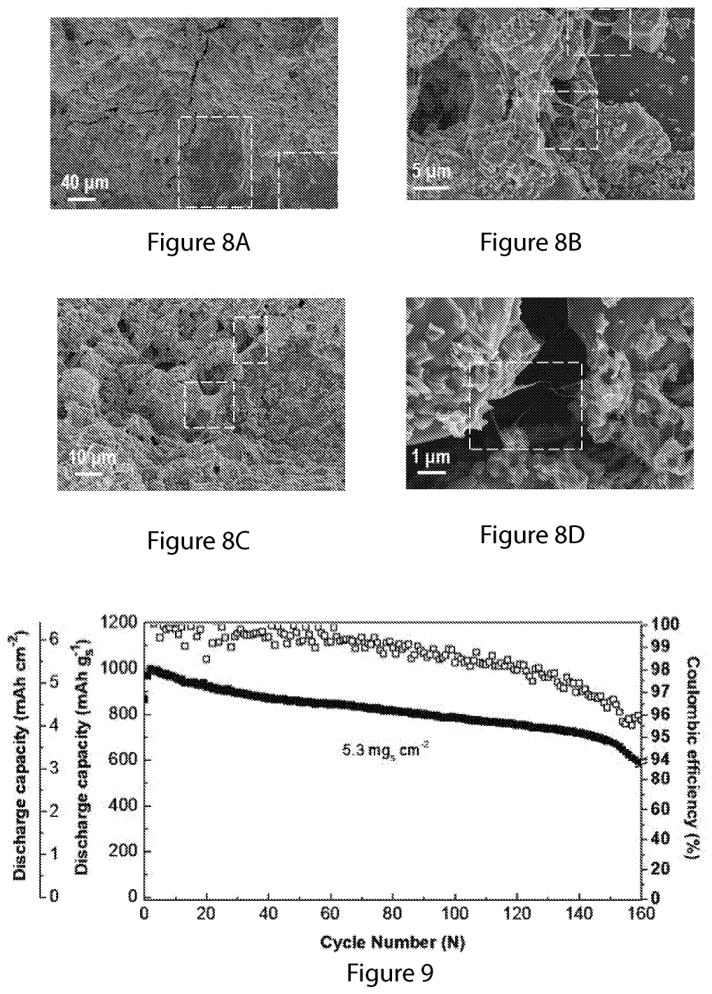

In another example a cathode formed from colloidal sulfur, CMC binder and activated carbon as the conductive agent, the use of colloidal sulfur is shown to be important to our approach and to the success of establishing bridging bonds. Replacing sub-micron-sized colloidal sulfur particles with several micrometer-sized crystalline sulfur particles in the formulation of the cathode resulted in a non-homogeneous microstructure and poor performance metrics due to the often disregarded coarsening effect of crystalline sulfur and the strong tendency of S atoms to catenate (34). FIGS. 8A to 8C shows SEM images of the bridging mechanism achieved at increasing resolutions for a cathode fabricated via the recipe of dry mixing/un-dissolved binder but replacing colloidal sulfur with the commonly used crystalline sulfur in the composition of the cathode show that achieving a homogenous distribution of the ingredients and a crack-free microstructure is not trivial due to the coarsening effect of crystalline sulfur. Particle coarsening, the macroscopic observation of particles increasing in size, is a combination of processes that increase the overall particle size and affect the distribution of particle sizes. Crystalline sulfur is the ground state, or atomic form of sulfur, S⁰, and is almost always used as the active material in the composition of sulfur cathodes. Sulfur atoms have a strong tendency to catenate, resulting in polymeric forms that can exist as rings or as chains of varying sizes and configurations, but is most stable as an 8-membered ring with a crown-shaped configuration (S8). These rings will quickly aggregate to form very small, but visible, forms of sulfur that are often in the tens to hundreds of nanometers to few micron size range of particles. It is then clear that dry mixing in such a system where one of the elements tend to aggregate cannot result in a uniform distribution of all the ingredients. In addition, bridging bonds might not be strong enough to bind such big neighboring clusters of particles. In FIG. 8A the presence of considerably large binder only areas demonstrates lack of homogeneity and the presence of macro-cracks shows lack of structural integrity—a direct result of particle coarsening. FIGS. 8B, 8C and 8D show different binding mechanisms across this cathode: successful bridging bonds (FIGS. 8B and 8C), networking mechanism to a more extent (FIG. 8D), and unsuccessful bridging bonds (FIG. 8D), hence the importance of using colloidal sulfur. FIG. 9 shows the inferior cycling performance of the cathode prepared via crystalline sulfur.

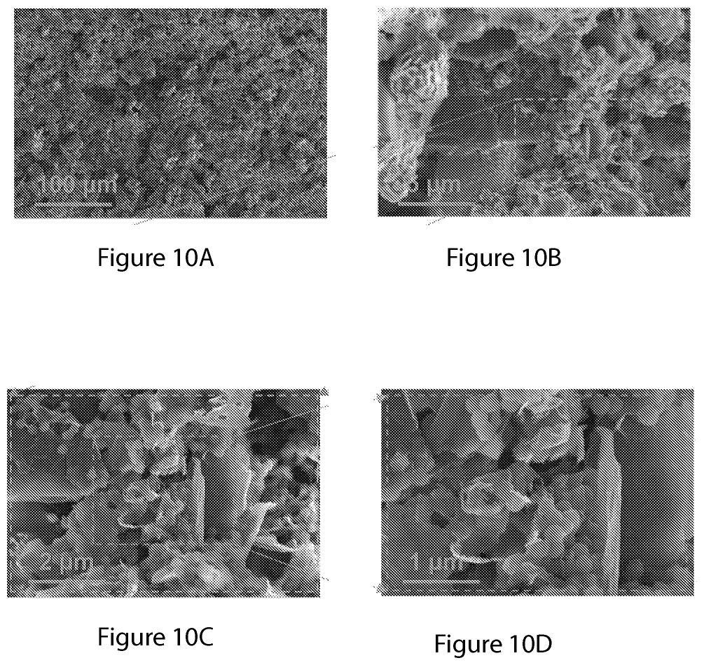

In yet a further example the effect off undissolved PVDF binder is explored for a cathode formed from colloidal sulfur and expanded graphite as the conductive agent. Another important factor related to aggregate behaviour of the ET cathode is that while cellulose maintains its adhesive properties in dry mixing method (despite being incompletely dissolved), other conventional binders such as PVDF lose their adhesive power under such conditions. Also, as far as we can ascertain there is no report on the formation of bridging bonds in the presence of solvents other than water. FIGS. 10A to 10D show SEM images of the bridging mechanism achieved at increasing resolutions for a PVDF-based cathode fabricated via the recipe of dry mixing/un-dissolved binder. We noted that when using PVDF as the binder, electrode fabrication is not trivial in particular in the presence of relatively large-surface area conductive agents, where very poor adhesion to the Al foil was observed (FIGS. 10A and 10B). Using expanded graphite as the conductive agent, resulted in relatively better coating, which made it possible to punch a few thick and relatively thick electrodes from the non-uniformly coated cathode and investigate their performance in coin cell assembly Nonetheless, from the visual observation of the coatings and the SEM images it is concluded that in contrast to cellulose, PVDF loses its adhesive power in the absent of sufficient dissolution in the solvent (NMP). Interestingly, very little agglomeration is seen and colloidal sulfur particles and expanded graphite powders have maintained their physical characteristics largely (FIGS. 10C and 10D).

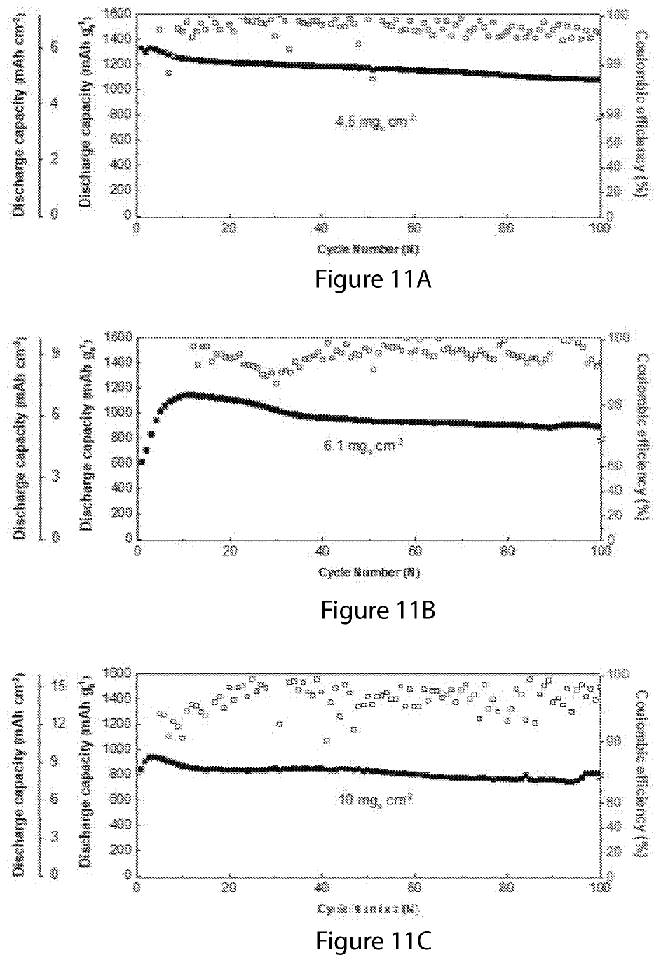

FIGS. 11A to 11C show the cycling performance of a cathode formed from colloidal sulfur, PVDF binder and expanded graphite as the conductive agent for varying concentrations of undissolved PVDF binder. Cycling performance of high and ultra-high loading sulfur cathodes with undissolved PVDF binder. At 4.5 mg cm⁻² (FIG. 11A) and 6.1 mg cm⁻² (FIG. 11B) and at 0.2 C rate, relatively high capacity and very good capacity retention is demonstrated and CE remains close to 100% after 100 cycles. At 10 mg cm⁻² (FIG. 11C) and 0.1 C rate, average capacity and high capacity retention is observed and the CE remains above 99% after 100 cycles. It is believed that the extremely open microstructure of this cathode allows for facilitated electrolyte diffusion and accommodating the cycling stress. However, the average electronic wiring across the electrode retards desired sulfur utilization. From a production perspective, for real world applications such as for use in a pouch cell configuration, homogenous, pinhole-free, and robust coatings on large-sizes of 2D metallic current collectors are the only industry-suitable solution, which is clearly not achievable with PVDF. Even so, one can conclude that dry mixing still demonstrates its most important merit in the case of using PVDF: an open structure where particles are not severely constrained amongst neighbouring particles.

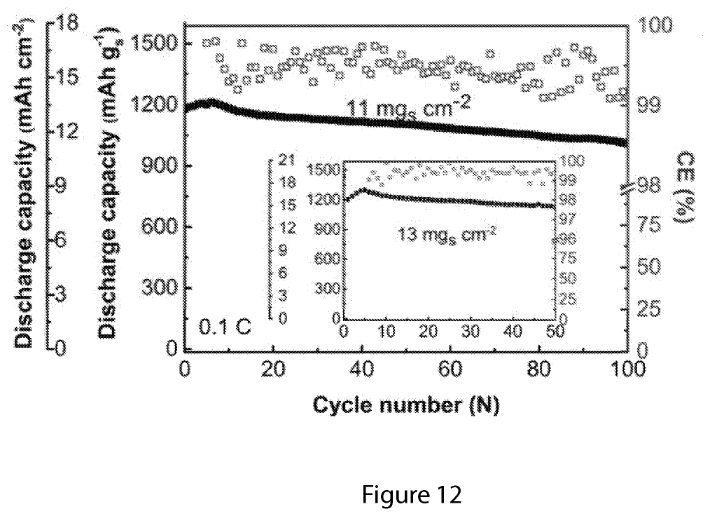

FIG. 12 shows the cycling performance of ultra-high loading cathodes prepared via the un-dissolved binder approach in terms of gravimetric capacity, areal capacity and columbic efficiency at 0.1 C rates.

The invention also encompasses a rechargeable energy cell made in accordance with the method, such a cell comprising a lithium anode a separator and a sulfur cathode produced in accordance to the method, wherein the cell further comprises a polysulfide retentive layer (also known as a carbon coated separator). The retentive layer may be coated on the sulfur cathode or be free standing between the sulfur cathode and the separator. The polysulfide retentive layer may be coated on a separator support and is preferably a high surface area carbon such as graphene, carbon or CNT. The retentive layer may also be a functional polymer such as gum Arabic, CMC and Na alginate.

In a further aspect the invention provides a rechargeable energy cell comprising a lithium anode, an electrolyte and a sulfur cathode produced in accordance with the method, wherein he electrolyte contains an organic solvent, preferably (DME) and 1,3-dioxolane (DOL). In a preferred embodiment, the solvent comprises a mixture of DME and DOL, such as a 50:50 (v/v) mixture. The electrolyte contains a soluble lithium salt to provide ionic conductivity between the anode and the cathode. The lithium salt comprises at least one selected from lithium bis(trifluoromethane)sulfonimide (LiTFSI) and lithium trifluoromethanesulfonate, and preferably comprises LiTFSI. The lithium salt may be present in the electrolyte at concentrations between 0.1 and 5.0 M, preferably between 0.25 and 1M, for example approximately 1.0 M. The electrolyte may comprise lithium nitrate (LiNO3), which is reported to suppress redox shuttling reactions of polysulfides at the anode, thereby increasing the coulombic efficiency of the cell. In some embodiments, LiNO3 may be present in the electrolyte in a concentration of between 0.05 and 1 M, for example 0.5M.

The reader will now appreciate the present invention which provides a new method of producing Sulfur electrodes resulting in improved performance and durability compared to known prior art methods. To summarise, the invention includes the steps of: Dry mixing of all the ingredients including active material, binder, conductive agent (and any other additive); semi dry processing of the mixture by adding minimal amount of solvent such that we obtain a castable paste but the binder remains mostly undissolved, preferably the most undissolved; and, casting the ultra-high viscous paste on a current collector. By placing minimum amounts of a binder between neighbouring particles, the process leaves increased space for material expansion (Expansion-tolerant architecture), imparts additional porosity for rapid ion diffusion, and maximizes the number of electrochemically available reaction sites (materials are not covered with the binder). Whilst specific examples of materials and solvents have been described, they should not be seen as limiting, as the process is suitable for a wide range of materials and solvents.

Further advantages and improvements may very be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A method of producing a sulfur cathode for a rechargeable energy storage cell, the method comprising steps of:
mixing, in a dry state, a sulfur containing source, a conductive agent and a binder to form a dry mix; and
mixing the dry mix with a solvent to form a processable mixture,
wherein an amount of the solvent added to the dry mix is below the solubility of the binder, and preferably well below the solubility of the binder.

2. The method as in claim 1, wherein the sulfur containing source comprises 5% to 95% sulfur by volume.

3. The method as in claim 1, wherein the sulfur containing source contains approximately 80% sulfur by volume.

4. The method as in claim 1, wherein the sulfur containing source is selected from the group of: crystalline sulfur, colloidal sulfur, Li₂S, and MoS_{2.}

5. The method as in claim 1, wherein the dry mix comprises 1% to 40% binder by volume.

6. The method as in claim 5, wherein the dry mix comprises approximately 5% binder by volume.

7. The method as in claim 5, wherein the binder is selected from the group of: Polytetrafluoroethylene (PTFE), polyvinylidene fluoride (PVDF), Gum Binders such as Gum Arabic, Xanthan gum, and Guar gum, Natural Cellulose based binders, Polysaccharides such as Na-CMC, Li-CMC, Na-Alginate, Polyacrylates, Aliphatic Polymers such as Polyvinyl butyral (PVB), and Aromatic Polymers such as Styrene-Butadiene Rubber.

8. The method as in claim 7, wherein the Polysaccharide based binder is selected from the group of: (CMC), Na-Alginate, and CNC.

9. (canceled)

10. (canceled)

11. (canceled)

12. (canceled)

13. (canceled)

14. (canceled)

15. The method as in claim 1, wherein the solvent is selected form the group of: water, NMP, alcohol-based solvents, and DMF.

16. The method as in claim 1, further comprising a step of processing the processable mixture onto a current collector to form the sulfur cathode.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. The method as in claim 2, wherein the sulfur containing source comprises more than 50% sulfur by volume.

32. The method as in claim 2, wherein the sulfur containing source comprises more than 65% sulfur by volume.

33. The method as in claim 2, wherein the sulfur containing source comprises more than 75% sulfur by volume.

34. The method as in claim 5, wherein the dry mix comprises less than 20% binder by volume.

35. The method as in claim 5, wherein the dry mix comprises less than 15% binder by volume.

36. The method as in claim 5, wherein the dry mix comprises less than 10% binder by volume.
